(19) United States
(12) Patent Application Publication
(10) Pub. No.: US 2012/0044374 A1
(43) Pub. Date: Feb. 23, 2012

(54) PHOTOGRAPHY LED LIGHTING AND EFFECTS GENERATION SYSTEM

(76) Inventors: RUDY G. POHLERT, CALABASAS, CA (US); Pat Grosswendt, Agoura, CA (US); Ken Fisher, North Hollywood, CA (US); Kevin C. Baxter, Glendale, CA (US); Fred H. Holmes, Cleveland, OK (US)

(21) Appl. No.: 13/031,158

(22) Filed: Feb. 18, 2011

Related U.S. Application Data
(60) Provisional application No. 61/306,433, filed on Feb. 19, 2010.

(51) Int. Cl. H04N 5/225; H05B 37/02

(52) U.S. Cl. 348/220.1; 348/370; 315/193; 348/E05.024

(57) ABSTRACT

A lighting apparatus comprises a light panel having a panel frame, and a plurality of LEDs or other light elements secured to the panel frame. The panel frame may be a portable frame. A self-contained battery unit securably attaches to the outside of the panel frame. The light panel may have a dimmer switch, and may also be capable of receiving power from a source other than the self-contained battery unit. The lighting apparatus can be mounted to a camera or a stand. The lighting apparatus may include an effects generator in communication therewith which generates a continuous light or a flash of light from the LEDs or other light elements. Diffusion lenses or color gels may be integrated with or detachable from the light panel.

### RELATED CASES

This application claims the benefit of U.S. Provisional Patent Application Ser. No. 61/306,433 filed on Feb. 19, 2010 and incorporates said provisional application by reference into this disclosure as if fully set out at this point.

### BACKGROUND OF THE INVENTION

1. Field of the Invention

The field of the present invention relates to lighting apparatus and systems as may be used in photography, film, television, and other applications.

2. Background

Lighting systems are an integral part of the film and photography industries. Proper illumination is essential when filming movies, television shows, or commercials, when shooting video clips, or when taking still photographs, whether such activities are carried out indoors or outdoors. In some instances, an illumination effect may also be desired for live performances on stage or in any other type of setting.

Historically, camera systems were designed for either video or still photography. The associated lighting systems were likewise categorized such that lighting systems for film, television or video were not necessarily suitable lighting systems for still photography. The principal difference between such lighting systems is that lighting that is intended for video shines continuously once activated, whereas lighting for photography is pulsed (strobed, flashed, etc.) in synchronization with the shutter of a camera to take a picture.

The emergence of digital photography has changed the camera industry dramatically. However, corresponding changes in the lighting industry have been slow to appear. For example, advances in technology have substantially blurred the distinctions between still and video photography. Modern video cameras are equipped to capture still images. Likewise digital SLR cameras are now capable of professional quality video image capture. Photographers who are present at news and sporting events now can use a single camera to capture both still images and video (including HD video) that is suitable for use in print (or on-line) publications. The video obtained by such cameras is suitable for use on broadcast television and/or for on-line access. Indeed, the video from such cameras is increasing being used in network and other news broadcasts in instances where there are no news crews on the ground and, thus, no other source of first person event coverage. However, the lighting system for such cameras is still wedded to separate systems for photograph and video. A need, therefore exists for a lighting system which is suitable for the demands of both video capture and still photography image capture.

In more particular, professional still photography has heretofore required the use of large lights that are situated on stands and that require access to a power supply that is most commonly supplied via a cord or cable. These lights and stands are typically heavy and require time to move into the studio and to position for a shoot. As a result spontaneous setup and use of such system is not feasible. This is particularly so in environments where spectators and others could trip over the cords/cables. Thus, a need also exists for a lighting and effects system which is portable and self powered to provide rapid setup, even in crowded environments.

A primary purpose of a lighting system is to illuminate a subject to allow proper image capture or achieve a desired effect. Often it is desirable to obtain even lighting that minimizes shadows on or across the subject. It may be necessary or desired to obtain lighting that has a certain tone, warmth, or intensity. It may also be necessary or desired to have certain lighting effects, such as colorized lighting, strobed lighting, gradually brightening or dimming illumination, or different intensity illumination in different fields of view.

Various conventional techniques for lighting in the film and television industries, and various illustrations of lighting equipment, are described, for example, in Lighting for Television and Film by Gerald Millerson (3rd ed. 1991), hereby incorporated herein by reference in its entirety, including pages 96-131 and 295-349 thereof, and in Professional Lighting Handbook by Verne Carlson (2nd ed. 1991), also hereby incorporated herein by reference in its entirety, including pages 15-40 thereof.

As one example illustrating a need for an improved lighting effects system, it can be quite challenging to provide proper illumination for the lighting of faces in still photography, especially for situations where close-up photographs are required. Often, certain parts of the face must be seen clearly. In addition, a need exists for such an effects lighting system that can be adapted for lightweight, battery powered operation as often required by still photographers.

The most common lighting systems in film, commercial, and photographic settings use either incandescent, fluorescent, or gas discharge light elements. However, conventional lighting systems have certain well known drawbacks or limitations which can limit their flexibility or effectiveness. Chief among their limitations are that because of their custom nature, both incandescent lighting systems and fluorescent lighting systems can be difficult to adapt to different or changing needs of a particular film project or shoot. For example, if the photographer decides that a different lighting configuration should be used, or wants to experiment with different types of lighting, it can be difficult, time-consuming, and inconvenient to re-work or modify the customized lighting setups to provide the desired effects. Furthermore, both incandescent lighting systems and fluorescent lighting systems are generally designed for placement off to the side of the camera, which can result in shadowing or uneven lighting.

A variety of lighting apparatus have been proposed for the purpose of inspecting objects in connection with various applications, but these lighting apparatus are generally not suitable for the movie, film or photographic industries. For example, U.S. Pat. No. 5,690,417, hereby incorporated herein by reference in its entirety, describes a surface illuminator for directing illumination on an object (i.e., a single focal point).

LED-based lighting apparatus have been developed for various live entertainment applications, such as theaters and clubs. These lighting apparatus typically include a variety of colorized LEDs in hues such as red, green, and blue (i.e., an “RGB” combination), and sometimes include other intermixed bright colors as well. These types of apparatus are not well suited for applications requiring more precision lighting, such as film, television, and so on. Among other things, the combination of red, green, and blue (or other) colors creates an uneven lighting effect that would generally be unsuitable for most film, television, or photographic applications. Moreover, most of these LED-based lighting apparatus suffer from a number of other drawbacks, such as requiring expensive and/or inefficient power supplies, incompatibility with traditional AC dimmers, lack of ripple protection (when connected directly to an AC power supply), inaccurate production of “white” light, and lack of thermal dissipation.

In the context of film and television, various attempts have been made to develop camera-mounted lighting fixtures; however, prior attempts to provide a suitable camera-mounted lighting fixture suffer from a variety of potential drawbacks. For example, conventional camera-mounted lighting fixtures using incandescent, gas discharge, or fluorescent lighting elements suffer from the same drawbacks as described above, and can cause undesirable shadowing or other side effects. Also, camera-mounted lighting fixtures which are designed to connect to the camera's battery can cause premature depletion of the battery. Other lighting fixtures are designed to be powered by a battery pack that is worn, typically on a belt, by the camera operator. Such battery belts are often heavy and cumbersome, and may require lengthy power cords that can interfere with camera maneuverability. Additionally, prior art camera-mounted light units have been proven to be a burning hazard since they are mounted in such close proximity to the camera operator and they can become very hot during operation. Accidental contact with the camera during operations or handling carries a risk of dealing a painful burn to the victim.

It would therefore be advantageous to provide a lighting apparatus or lighting effects system that is versatile and portable, and may find use in a variety of applications. It would further be advantageous to provide a lighting apparatus or lighting effects system that is well suited for use in the film, commercial, and/or photographic industries, and/or with live stage performances, that overcomes one or more of the foregoing disadvantages, drawbacks, or limitations.

### SUMMARY OF THE INVENTION

Applicant incorporates herein by reference U.S. Pat. No. 7,429,117 as if fully set out at this point.

The invention is generally directed in one aspect to a novel and versatile lighting apparatus and effects generator. According to one embodiment as disclosed herein, a preferred lighting apparatus configuration comprises a light having a panel frame, with a plurality of semiconductor light elements, such as LEDs, secured to the panel frame. A self-contained battery unit may be attached to the panel frame. In some preferred embodiments the battery unit might be removable from the panel frame and in other embodiments it might be incorporated into (e.g., made a part of) the panel frame or the camera body. Additionally, it should be noted that the battery pack might be a single purpose or customized device suitable for a particular camera or a more conventionally it might be a compartment into which one or more standard batteries (e.g., A, AA, C, etc.) might be placed. When attached together, the light panel and self-contained battery unit function as an integrated lighting apparatus. Optionally, the light panel may have an integrated dimmer switch, and may also be capable of receiving power from a source other than the self-contained battery unit.

The instant lighting and effects apparatus may be mounted to a video or still camera, where the term “mounted” should be broadly construed to include instances where the lighting and effects apparatus are removably mounted as well as instances where the lighting apparatus is integral to the associated camera. Alternatively it may be mounted to a stand or tripod.

The lighting apparatus and effects generator of the instant invention is suitable for providing continuous illumination for a subject during video photography. The continuous illumination is also particularly suited as a modeling light for still photography. Furthermore, when a burst of light such as a flash or strobe is required, the lighting apparatus is capable of generating this required effect in a burst mode, preferably in synchronization with a shutter of a still or other camera. The lighting apparatus may also be dimmable in both the continuous or burst mode operation. As such, the lighting and effect generator of the present disclosure is suitable for video capture and/or still photography or the combination of both. In addition the light emitted may be shaped or color balanced as desired. Accordingly, continuous illumination is for modeling and a burst mode for flash or strobe is accomplished in the same light emitter in the same color balance (same quality of light).

The lighting and effects system of the present disclosure will also be preferably capable of providing aperture portion control. Additionally, the preferred embodiment of the instant lighting and effects system will be capable of F-stop control through an input signal to its microprocessor. Further, through the lens metering of the lighting device may be accomplished by a signal from the camera received by the microcontroller in the lighting and effects device. Color/brightness balance can thus be achieved.

Slave flashes will include self-contained electronic flash units that respond to external triggers of some kind. Among the sorts of triggers that would be suitable for use with the instant invention are radio frequency (RF) signals, infrared (IR) signals, and optical signals.

Optical slave flashes will be triggered by light. These embodiments have sensors that detect a light pulse from another flash device and then trigger immediately themselves. Since they respond so quickly, the time delay between the trigger flash and the slave flash does not affect the exposure of the photograph. Optical flash units historically had a problem in large gatherings where multiple flashes were present because an adjacent flash could also trigger the slave flash units. Manufacturers have addressed this problem by encoding the light bulbs so as to be immune from secondhand flashes. Others have addressed the problem through the use of IR or RF signals. The lighting and effects system of the present invention is particularly suited for use with such optical, IR or RF slave flash systems due to the lower power consumption and longer duration of these triggers over prior art flash technologies.

In various forms and embodiments, the lighting and effects generator of the present disclosure may be adapted for being mounted to a camera or a stand, and may include adapters for such a purpose. The lighting apparatus may also be provided with a diffusion lens or color gels, which may be integrated with or detachable from the lighting and effects generator. The lighting and effects generator may conveniently be provided in the form of a kit, with one or more of a light panel, self-contained battery unit, compact stand, connecting cable(s), adapter(s), lenses or color gels, and so on, being provided in a single package to allow flexibility and versatility to users in the field.

Further embodiments, variations and enhancements are also disclosed herein.

### BRIEF DESCRIPTION OF THE DRAWINGS

FIG. 1 illustrates one environment in which the instant invention might be utilized.

FIG. 2 is a block diagram of a lighting effects system showing various components of a preferred system.

FIGS. 3A and 3B contain illustrations of different approaches to mounting a preferred embodiment of the instant invention on video and still cameras, respectively.

FIG. 4 is a diagram illustrating aspects of the lighting effect provided by a lighting assembly such as, for example, shown in FIG. 1.

FIGS. 5A and 5B are a block diagrams of two different types of electronic controllers as may be employed, for example, in the lighting effects system illustrated in FIG. 2.

FIG. 6 is a diagram that illustrates a preferred embodiment of the lighting system and effects generator of the present disclosure.

FIGS. 7A and 7B are diagrams of a lighting apparatus in accordance with one embodiment as disclosed herein.

FIGS. 8A and 8B are diagrams of the lighting apparatus in FIGS. 7A-B together with an attachable battery unit.

FIGS. 9A and 9B are diagrams showing attachment of the lighting apparatus in FIGS. 7A-B and 8A-B to the attachable battery unit of FIGS. 8A-B.

FIG. 10 is a diagram of one embodiment of a lighting effects system having at least two different lamp colors.

FIG. 11 is a diagram of another embodiment of a lighting effects system having at least two different lamp colors.

FIG. 12A is a diagram illustrating placement of a lens and optional color gel on the integrated light panel and battery apparatus of FIGS. 8A-B, and FIG. 12B is a side view diagram illustrating the lens in place.

FIG. 13 is a diagram showing one possible means for mounting an LED light panel to a camera.

FIG. 14 is a diagram illustrating attachment of mounting pin(s) to the lighting apparatus shown in FIGS. 7A-B.

FIG. 15 is another view of a diagram illustrating attachment of mounting pin(s) to the lighting apparatus shown in FIGS. 7A-B.

FIG. 16 is still another view of a diagram illustrating attachment of mounting pin(s) to the lighting apparatus shown in FIGS. 7A-B.

FIG. 17 is a diagram of a lighting array mounted atop a circuit board.

FIG. 18 is a functional block diagram illustrating circuits or components of an LED light panel in accordance with one embodiment as disclosed herein.

FIGS. 19A and 19B contain preferred operating logic flow charts that are suitable for use with the instant invention.

### DETAILED DESCRIPTION OF PREFERRED EMBODIMENT(S)

Before describing preferred embodiment(s) of the present invention, an explanation is provided of several terms used herein.

The term “lamp element” is intended to refer to any controllable luminescent device, whether it be a light-emitting diode (“LED”), light-emitting electrochemical cell (“LEC”), a fluorescent lamp, an incandescent lamp, or any other type of artificial light source. The term “semiconductor light element” or “semiconductor light emitter” refers to any lamp element that is manufactured in whole or part using semiconductor techniques, and is intended to encompass at least light-emitting diodes (LEDs) and light-emitting electrochemical cell (LECs).

The term “light-emitting diode” or “LED” refers to a particular class of semiconductor devices that emit visible light when electric current passes through them, and includes both traditional low power versions (operating in, e.g., the 60 mW range) as well as high output versions such as those operating in the range of 1 Watt and up, though still typically lower in wattage than an incandescent bulb used in such application. Many different chemistries and techniques are used in the construction of LEDs. Aluminum indium gallium phosphide and other similar materials have been used, for example, to make warm colors such as red, orange, and amber. A few other examples are: indium gallium nitride (InGaN) for blue, InGaN with a phosphor coating for white, and Indium gallium arsenide with Indium phosphide for certain infrared colors. A relatively recent LED composition uses Indium gallium nitride (InGaN) with a phosphor coating. It should be understood that the foregoing LED material compositions are mentioned not by way of limitation, but merely as examples.

The term “light-emitting electrochemical cell” or LEC” refers to any of a class of light emitting optoelectronic devices comprising a polymer blend embedded between two electrodes, at least one of the two electrodes being transparent in nature. The polymeric blend may be made from a luminescent polymer, a sale, and an ion-conducting polymer, and various different colors are available. Further background regarding LECs may be found, for example, in the technical references D. H. Hwang et al, “New Luminescent Polymers for LEDs and LECs,” Macromolecular Symposia 125, 111 (1998), M. Gritsch et al, “Investigation of Local Ions Distributions in Polymer Based Light Emitting Cells,” Proc. Current Developments of Microelectronics, Bad Hofgastein (March 1999), and J. C. deMello et al, “The Electric Field Distribution in Polymer LECs,” Phys. Rev. Lett. 85 (2), 421 (2000), all of which are hereby incorporated by reference as if set forth fully herein.

The term “color temperature” refers to the temperature at which a blackbody would need to emit radiant energy in order to produce a color that is generated by the radiant energy of a given source, such as a lamp or other light source. A few color temperatures are of particular note because they relate to the film and photographic arts. A color temperature in the range of 3200° Kelvin (or 3200° K) is sometimes referred to as “tungsten” or “tungsten balanced.” A color temperature of “tungsten” as used herein means a color temperature suitable for use with tungsten film, and, depending upon the particulars of the light source and the film in question, may generally cover the color temperature range anywhere from about 1000° Kelvin to about 4200° Kelvin. A color temperature in the range of 5500° Kelvin (or 5500° K) is sometimes referred to as “daylight” or “daylight balanced.” Because the color of daylight changes with season, as well as changes in altitude and atmosphere, among other things, the color temperature of “daylight” is a relative description and varies depending upon the conditions. A color temperature of “daylight” as used herein means a color temperature suitable for use with daylight film, and, depending upon the particulars of the light source and the film in question, may generally cover the color temperature range anywhere from about 4200° Kelvin to about 9500° Kelvin.

Turning now to a first preferred embodiment, a lighting effects system is provided herein that comprises an arrangement of lamp elements on a panel or frame. The lamp elements may be embodied as low power lights such as light-emitting diodes (LEDs) or light emitting electrochemical cells (LECs), for example, and may be arranged on the panel or frame in a pattern so as to provide relatively even, dispersive light. The panel or frame may be relatively lightweight, and may include one or more circuit boards for direct mounting of the lamp elements. A power supply and various control circuitry may be provided for controlling the intensities of the various lamp elements, either collectively, individually, or in designated groups, and, in some embodiments, through pre-programmed patterns. Additionally, and according to the instant invention, this lighting effects system is capable of providing steading or continuous lighting and, upon demand, strobing, pulsing, or otherwise increasing the output of the lighting system relative to the continuous lighting level for use in, for example, digital photography.

In another embodiment, a lighting effects system comprises an arrangement of low power lights mounted on a frame having an opening through which a camera can view a lighted subject, and one or more mounting brackets for attaching the frame to a camera. The low power lights may be embodied as LEDs or LECs, for example, arranged on the frame in a pattern of concentric circles or other uniform or non-uniform pattern. The low power lights may be electronically controllable so as to provide differing intensity levels, either collectively, individually, or in designated groups, and, in some embodiments, may be controlled through pre-programmed patterns. Again, and according to a preferred variation, this lighting effects system will be capable of providing continuous and pulsed lighting suitable for use in, for example, video and still photography applications. Note that “continuous lighting” should be broadly interpreted herein to include both lighting elements that truly emit light continuously as well as light sources that might appear to be continuous to the camera or the human eye even if they are in reality generated by a series of closely spaced (in time) light pulses (e.g., if the light is generated using pulse width modulation).

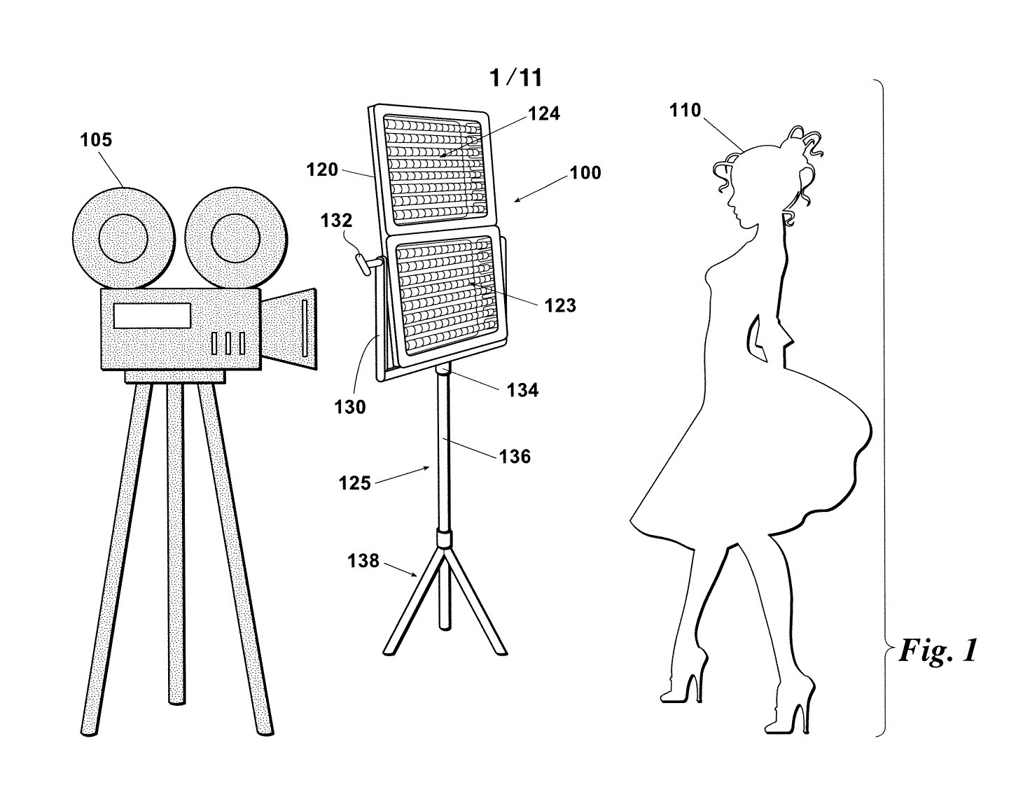

FIG. 1 illustrates the general environment in which one preferred embodiment of the instant invention might be used. In some instances, a video camera 105 might be directed toward a subject 110 that is being illuminated by inventive light 100. The camera 105 of FIG. 1, while illustrated as a motion picture-type camera, could be any type of image capture or optical viewing device, whether analog or digital in nature. For example, the camera 105 might use film, video tape, or solid-state image capture circuitry (e.g., CCDs) and may be a still photography camera, a motion picture camera, or some combination of the two.

As is illustrated in FIG. 1, according to this embodiment the inventive light panel assembly 100 preferably utilizes a panel light frame 120 which is attached to a stand 125. The panel light frame 120 may include multiple panel light sections 123, 124, or may be a single unitary panel light. The stand 125 may be of a conventional nature, with a C-shaped yoke 130 for securing the panel light frame 120 crossbar and allowing it to tilt for directional lighting. A twisting handle 132 may be used to lock the panel light frame 120 at a particular angle. The C-shaped yoke 130 may be rotatable or pivotable by placement atop a fluid head 134, which, in turn, is positioned atop a stem 136 and tripod 138. The panel lighting assembly 100 thus conveniently provides a variety of directional lighting options for the panel light frame 120.

In alternative embodiments, a ball and socket mechanism may be used to rotate or pivot an attached lighting panel, using socket joints similar to those used, for example, for computer monitors. Likewise, in any of the foregoing embodiments, motorization may be employed to control the movement of the lighting yokes or stand. Motorized controls are well known in the art for lighting apparatus (particularly in the performing arts field) and the motorized control may be either automated or manual in nature.

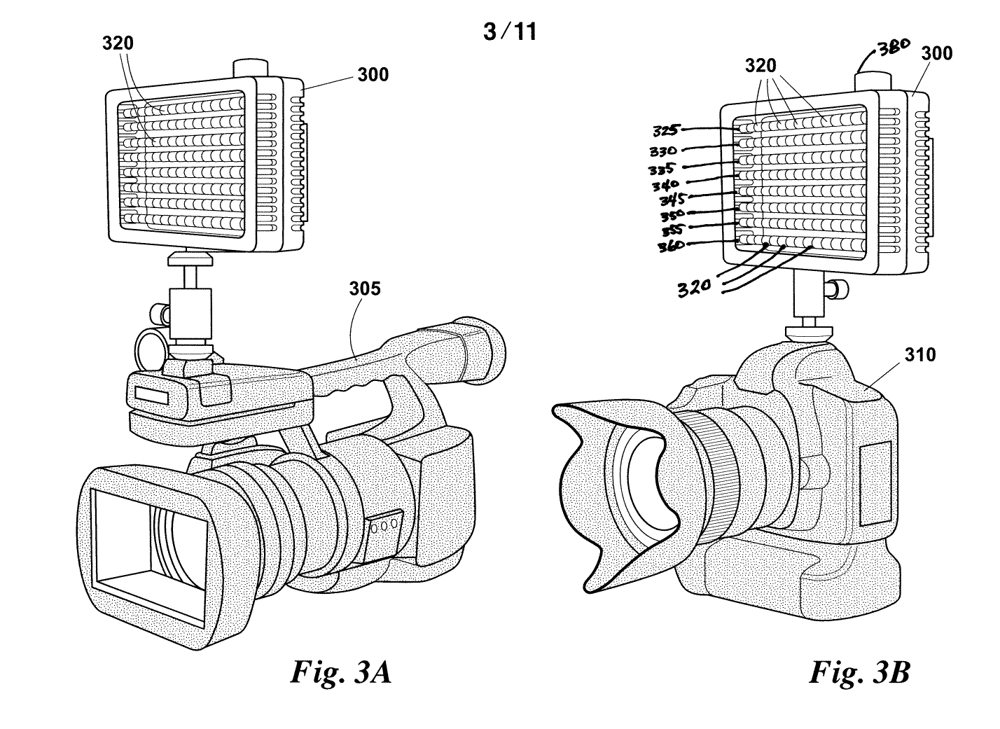

FIGS. 3A and 3B illustrate another preferred aspect of the instant invention. In some arrangements, the lighting device might be directly mounted on a camera as opposed to being stand-mounted. In FIG. 3A, a preferred embodiment of the instant invention is shown mounted on a conventional video camera and in FIG. 3B a similar example of the instant invention is shown mounted on a conventional SLR camera. As should be clear from these figures, embodiment 300 is designed to be mounted on a video camera 305 or digital still camera 310 and operate in conjunction therewith.

Although a panel-type configuration is preferred, other configurations of the instant invention are certainly possible and have been contemplated by the instant inventors (e.g., a ring-shaped embodiment with light sources around its periphery). That being said, FIG. 4 illustrates one reason why a panel-type arrangement is preferred in many circumstances. FIG. 4 illustrates the effect of the lighting frame assembly such as light frame 100 with light elements or lamps, collectively 320 generally arranged as shown in FIGS. 3A and 3B. If a panel-type lamp configuration is utilized, radiating light regions 420 and 421 from lamps arranged on the front surface of the lighting frame 100 will overlap one another in a manner so as to provide lighting from multiple angles. With an arrayed pattern of lamp segments, the subject 410 may be relatively evenly illuminated from every angle. The camera (including any type of image capture device, whether film-based, solid state/CCD, or otherwise) may be placed in any desired manner with respect to a lighting frame 100.

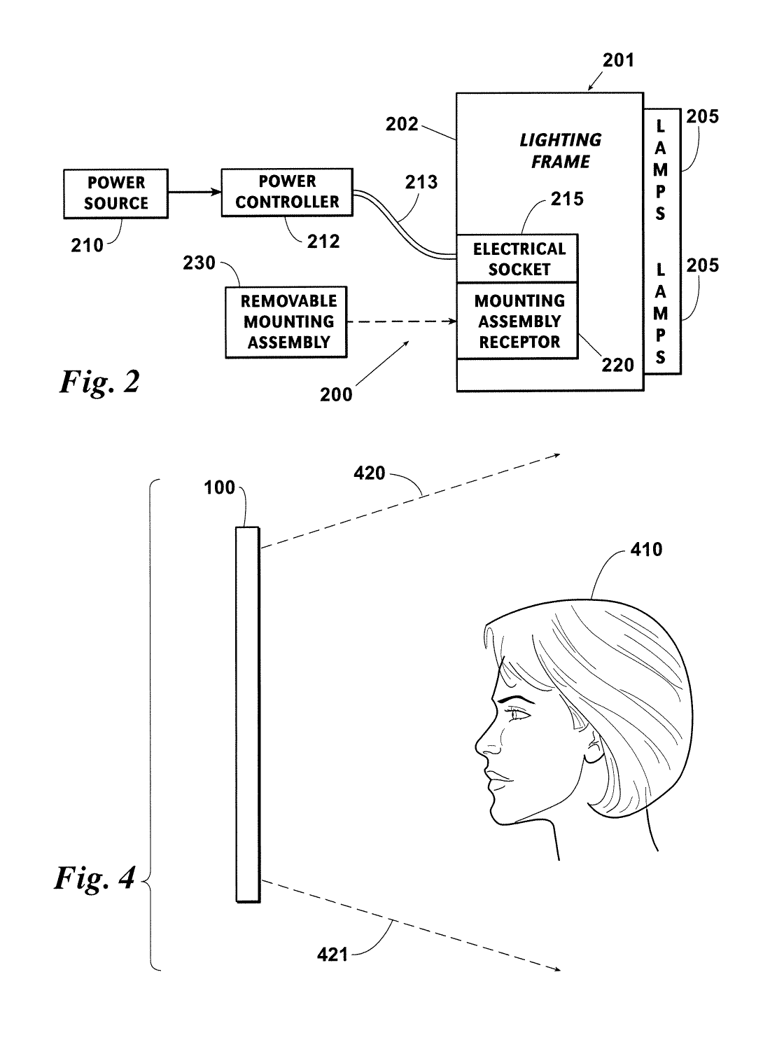

Returning now to the general diagram of a lighting effects system 201 illustrated in FIG. 2 (although the following comments will apply to various other embodiments such as the lighting assemblies shown in FIGS. 3A and 3B), the LEDs or other low power lamps 205 may be operated at a standard direct current (DC) voltage level, such as, e.g., 12 volts or 24 volts, and may be powered by a power source 210 controlled by a power controller 212 such as is generally shown in FIG. 2. The power source 210 can generally comprise a standard electrical outlet (i.e., nominal 110 volt AC power line), although in various embodiments the power source 210 could also be a battery having sufficient current to drive the LEDs or other low power lamps 205. In some embodiments, the power controller 212 may be omitted, and the lighting frame 202 may be connected directly to the power source 210.

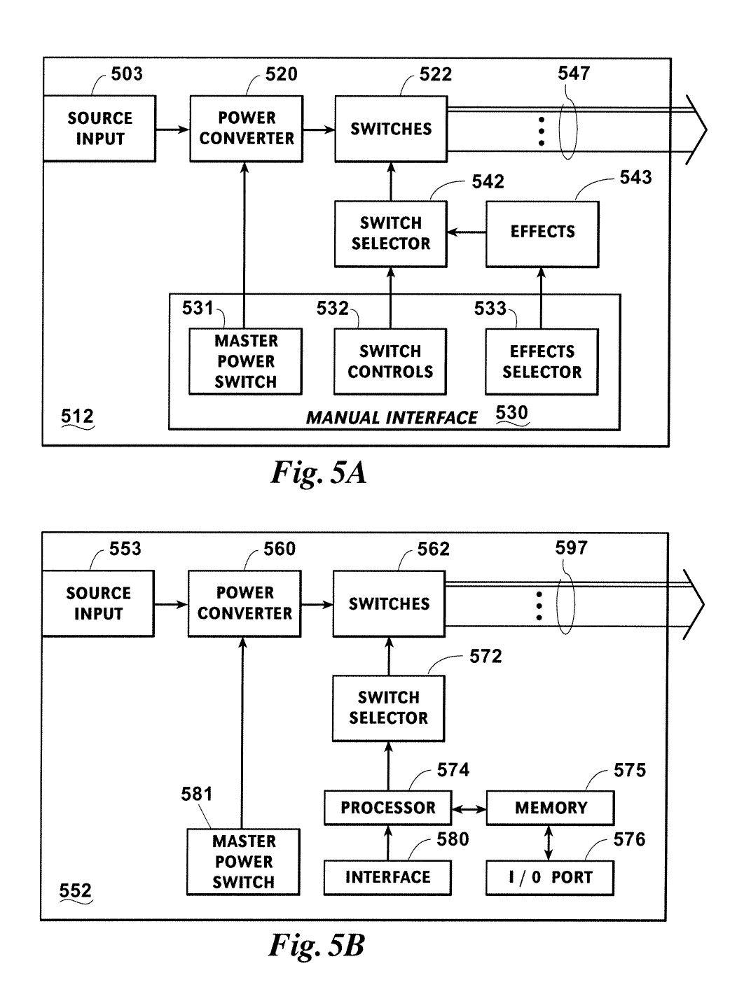

Block diagrams of two different types of power controllers 212 as may be used in various embodiments as described herein are illustrated in FIGS. 5A and 5B, respectively. With reference to FIG. 5A, a first type of power controller 512 has an input for receiving an AC power source 503, and outputs a plurality of power wires 547 preferably through a cable (e.g., cable 213 shown in FIG. 2) for connection to the lighting frame 202. The power controller 512 may further comprise a power converter 520, the nature of which depends upon the type of power source 210. If the power source is an AC source, the power converter 520 may comprise an AC-to-DC converter and appropriate step-down power conversion circuitry (e.g., a step-down transformer). On the other hand, if the power source is a DC source (e.g., a battery), the power converter 520 may comprise a DC-to-DC converter, if necessary. The design and construction of power converters is well known in the field of electrical engineering, and therefore is not be described herein in detail.

The power converter 520 is preferably connected to a plurality of switches 522, which may be solid state devices (e.g., transistors) or analog devices (e.g., relays), each switch controlling power delivered by the power converter 520 to one of the wires 547 output by the power controller 512. A switch selector 542 controls the on/off state each switch (or group) in the set of switches 522. A manual interface 530 is provided to allow operation of the switches 522 according to manual selection. The manual interface 530 may include a master power switch 531, switch controls 532, and, optionally, an effects selector 533. The switch controls 532 may include an individual manual switch, button or other selection means for each individual switch provided in the set of switches 522, or else may comprise a control mechanism (such as knob or reduced number of manual switches, buttons or other selection means) for selecting groups of switches 522 according to predesignated arrangements. As but one example, assuming a light arrangement such as shown in FIG. 3B (taken in combination with FIG. 5A), a knob provided as part of the switch controls 532 could have a first setting to select all of the light segments 325, 330, 335, 340, 345, 350, 355, 360 thereby illuminating all 320 light elements, a second setting to select every other light segments 325, 335, 345 and 355, and a third setting to select every fourth of light segment 325, 340, 360, thus providing options of 100%, 50% and 25% total light output. The switch selector 542 would then convert each knob setting to a set of control signals to the appropriate switches 522, which in turn would control power to the wires 547 supplying power to the light segments.

As another example, the switch controls 532 could include an individual manual switch, button or other selection means for each light segment 325, 330, 335, 340, 345, 350, 355 and 360 or group of light segments in the lighting arrangement.

An effects generator 543 (FIG. 5A) may optionally be included in the power controller 512, along with an effects selector 533 which forms part of the manual interface 530. The effects generator 543 may provide the ability to create various lighting effects, such as, e.g., dimming, strobing, pulsation, or pattern generation. The effects selector 543 may affect all of the switches 522 simultaneously, or else may affect individual switches or groups of switches 522, depending upon the desired complexity of the lighting effects. Dimming may be accomplished, for example, through a manual control knob or multi-position switch on the effects selector 533. The dimming control may be electronically implemented, for example, in an analog fashion through a variable resistive element, or in a digital fashion by detecting the selected manual setting and converting it to selecting power setting through, e.g., selected resistive elements in a resistive ladder circuit or through a variable duty cycle delivered to the lights. Where the switches 522 are implemented, for example, as controllable variable amplifiers, the selectable resistance may be used to control the output of each amplifier and thereby the light output by the amplifier's respective light segment 325-360 (or group of light segments FIG. 3B). In other embodiments, the dimming control may optionally be applied to the output of switches 522. Where dimming control is applied collectively, it may be implemented by applying the selected dimming control level to the incoming signal from the power converter 520, which is supplied to all of the switches 522 collectively. Other variations for implementing dimming control are also possible and will be apparent to those skilled in the art of electrical engineering.

Strobing may be accomplished by generating an oscillating signal and applying it as a control signal either upstream or downstream from the switch selector 542. The frequency of oscillation may be selectable via a manual knob, switch or other selection means as part of the effects selector 533.

Pattern generation may be accomplished by, e.g., manual selection from a number of predefined patterns, or else through an interface allowing different pattern sequencing. Patterns may include, for example, strobing or flashing different groups of light segments 325, 330, 335, 340, 345, 350, 355, and 360 (given the example of FIG. 3B) in a predefined sequence (which may be a pseudo-random sequence, if desired), strobing or flashing different light elements 320 of the light segments 325-360 in a predefined (or pseudo-random) sequence, gradually dimming or brightening light segments 325-360 (individually, in groups, or collectively), or various combinations of these effects.

Alternatively, rather than providing a separate effects selector 533, certain effects may be combined with the switch controls 532. For example, a dimmer switch (knob) 380 could be used to both activate a particular light segment (such as 340), or group of light segments (such as 325, 340, and 360) and also control light output via rotation of the dimmer switch (knob) 380.

FIG. 5B is a block diagram showing another example of a power controller 552 as may be used, for example, in the lighting effects system 200 of FIG. 2 or other embodiments described herein. Like the power controller 512 shown in FIG. 5A, the power controller 552 shown in FIG. 5B includes a power source input 553 connected to a power converter 560. It further includes a set of switches 562 receiving power from the power converter 560, and providing power to individual wires 597 which are conveyed, preferably by cable, to the lighting frame assembly 201 of the lighting effects system 200. The power controller 552 also includes a switch selector 572, which may comprise, for example, a set of registers which provide digital signals to the switches 562 to control their on/off state.

The power controller 552 includes a processor 574 which may be programmed to provide various lighting effects by manipulating the switch selector 572 (for example, by changing values in registers which control the on/off states of the switches 562). The processor 574 may interface with a memory 575, which may comprise a volatile or random-access memory (RAM) portion and a non-volatile portion (which may comprise, e.g., ROM, PROM, EPROM, EEPROM, and/or flash-programmable ROM), the latter of which may contain programming instructions for causing the processor 574 to execute various functions. The memory 575 may be loaded through an I/O port 576, which may include an electrical serial or parallel interface, and/or an infrared (IR) reader and/or bar code scanner for obtaining digital information according to techniques well known in the field of electrical engineering and/or electro-optics. An interface 580 may also be provided for programming or otherwise interfacing with the processor 574, or manually selecting various lighting effects options through selectable knobs, switches or other selection means, as generally explained previously with respect to FIG. 5A. The processor-based control system illustrated in FIG. 5B may also include other features and components which are generally present in a computer system.

In operation, the processor 574 reads instructions from the memory 575 and executes them in a conventional manner. The instructions will generally cause the processor 574 to control the switch selector by, e.g., setting various digital values in registers whose outputs control the switches 562. The programming instructions may also provide for various lighting effects, such as dimming, strobing, pulsation, or pattern generation, for example. To accomplish dimming, the processor 574 may be programmed select binary-encoded values to load into registers of the switch selector 572, which in turn select a variable resistance value which controls the output from each individual or group of switches 562. To accomplish strobing, the processor 574 may be programmed to turn the switches 562 on and off according to a predesignated pattern dictated by the programming instructions. The processor 574 may make use of one or more electronic timers to provide timing between on and off events. The programming instructions may provide that the switches 562 are turned on and off according to designated sequences, thus allowing the capability of pattern generation via the processor 574. As mentioned before, patterns may include, for example, strobing or flashing all or different groups of light segments 325-360 (given the example of FIG. 3) in a predefined (or pseudo-random) sequence, strobing or flashing different low power lamps 320 of the light segments 325-360 in a predefined (or pseudo-random) sequence, gradually dimming or brightening the light segments 325-360 (individually, in groups, or collectively), or various combinations of these effects is contemplated. Predefined (or pseudo-random) sequence, gradually dimming or brightening the lamps 320 (individually, in groups, or collectively), or various combinations of these effects is contemplated.

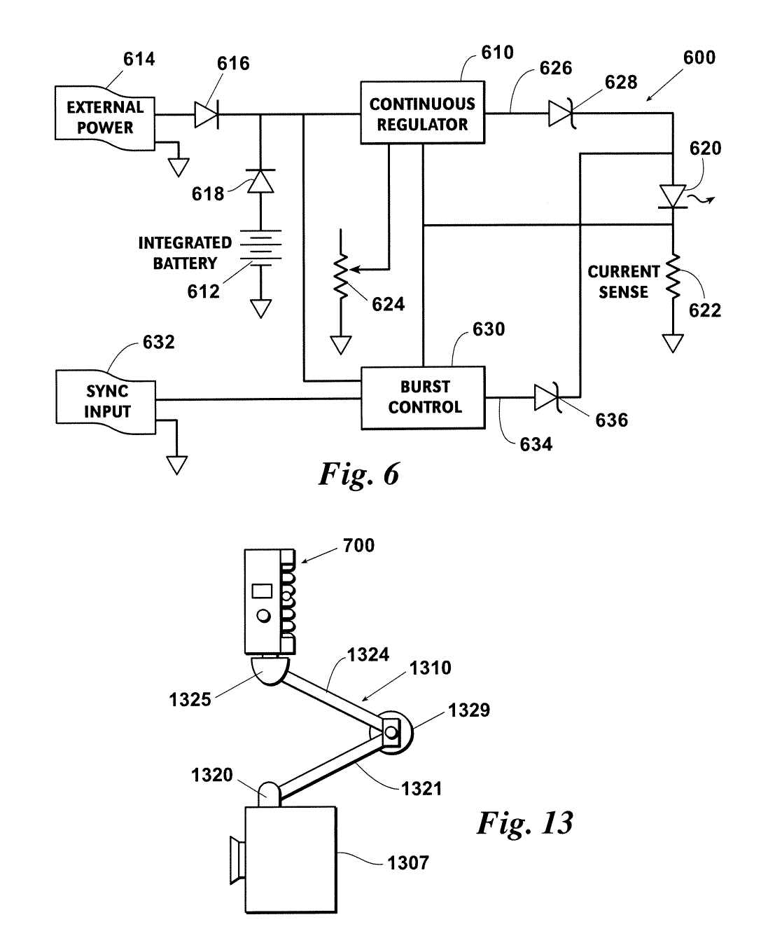

Turning next to FIG. 6 which illustrates a preferred embodiment of the instant lighting and effects system, continuous regulator 610 receives power from either battery 612, or optionally through external power connector 614. Preferably diodes 616 and 618 essentially “or” the power from either source 612 or 614 such that the source with the highest voltage will provide the power to regulator 610. Diodes 616 and 618 further preferably provide reverse voltage protection such that an inadvertent insertion of battery 612 or application of reversed voltage at connector 614 will not damage regulator 610.

In a preferred arrangement, regulator 610 selectively regulates the current through LED array by measuring the voltage across current sense resistor 622. Potentiometer 624 provides a selectable reference to regulator 610 to set the level at which the LED current will be regulated.

Preferably regulator 610 is a switch mode regulator which will provide true direct current to LED array 620. One such device suitable for the present invention is Model TPS 61165 manufactured by Texas Instruments of Dallas, Tex. However, a linear regulator would also work satisfactorily, albeit perhaps at a somewhat lower efficiency. Alternatively, regulator 610 could employ pulse width modulation to accomplish dimming.

To obtain a flash of light from LED array 620, in the preferred embodiment a burst control circuit 630 is provided. Typically, circuit 630 will maintain a reservoir of electrical energy at a voltage somewhat higher than the output 626 of regulator 610 when a sync pulse, or switch closure, is provided at sync input 632. When burst circuit 630 detects a sync pulse, the stored energy is provided at output 634, preferably for a predetermined period of time causing LED array 620 to produce a flash of light. In one preferred embodiment, the energy stored by circuit 630 is a known quantity which will drive LED array 620 in a known manner, by way of example and not limitation, perhaps at eight times its maximum continuous current. Alternatively, burst control circuit may use feedback from current sense resistor 622 to control the current during the flash duration.

In a preferred embodiment, diode 628 prevents the burst output 634 from adversely affecting regulator 610 and diode 636 prevents the output of regulator 610 from adversely affecting circuit 630.

FIGS. 3, 4, 7A and 7B are diagrams of a lighting apparatus 700 in accordance with one or more embodiments as disclosed herein. The lighting apparatus 700 is preferably portable and versatile in nature, as further described herein. The lighting apparatus 700 in this example includes a panel, fixture or frame (hereinafter “panel”) 702 having a plurality of semiconductor light elements (such as LEDs or LECs) 4705 mounted on a mounting surface 704 of the panel 702. Note that for purposes of the instant disclosure, a surface mount semiconductor light element is any LED (semiconductor light element) that does not have leads for through hole mounting. Persons of ordinary skill in the art will readily understand the meaning of “through hole” as that term is used in the semiconductor industry.

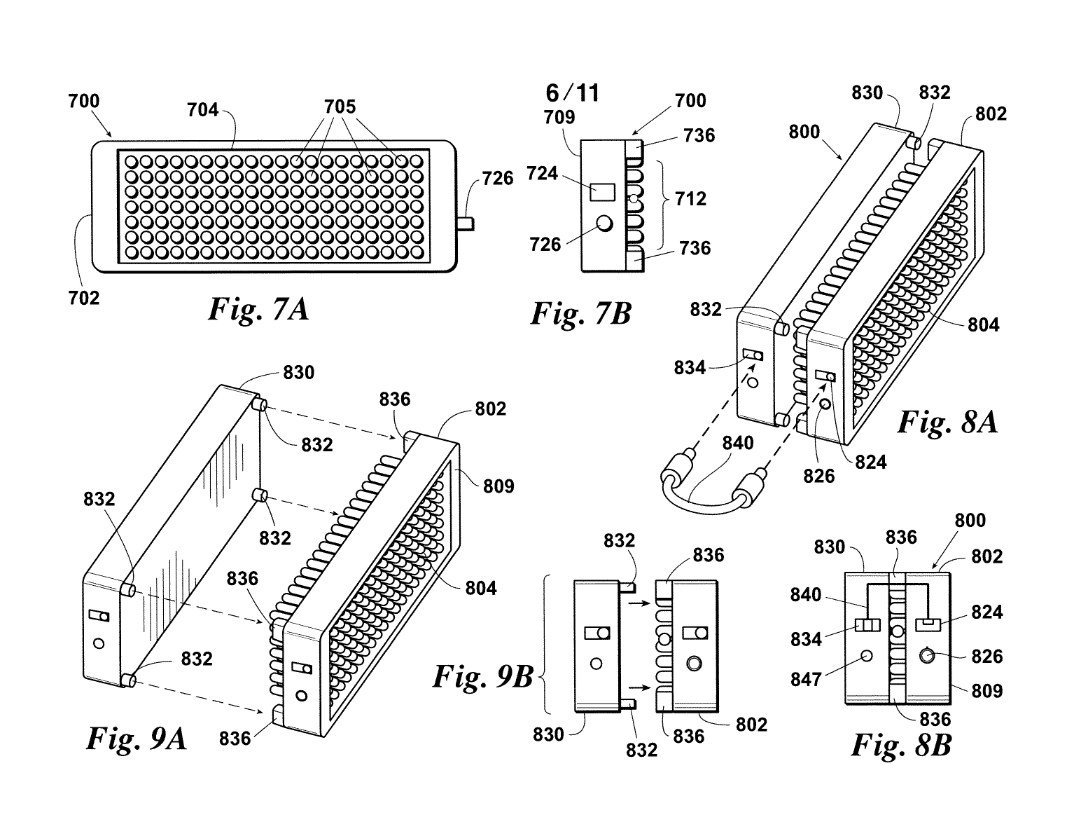

As illustrated in FIG. 7A, the semiconductor light elements 705 may be disposed in uniform arrays to provide a broad light source. The mounting surface 704 may include one or more circuit board assemblies, generally constructed in accordance with the principles described with respect to FIG. 17. Although the semiconductor light elements 705 are illustrated as being arranged in uniform arrays, they may be arranged in other patterns as well. Furthermore, while the panel 702 is shown as being generally rectangular in shape, the panel 702 may alternatively be of any suitable shape, including, for example, hexagonal, octagonal, or other polygonal or semi-polygonal, or round, oval, square, or ring-shaped.

The semiconductor light elements 705 may be surface mounted or through hole. The light elements or LEDs may have screw-in bases or other similar physical attachment means, such that the LEDs can be easily removed and replaced.

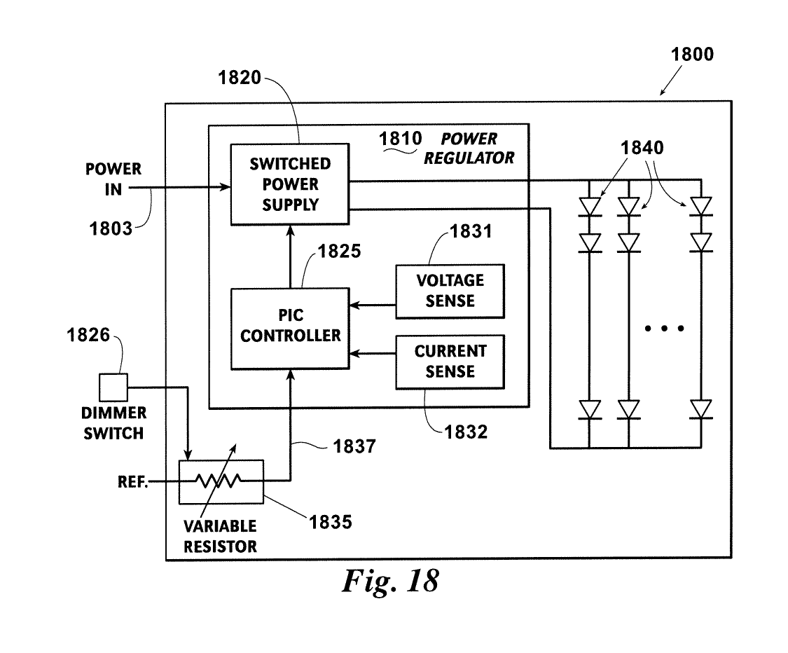

The panel 702 may further include an integrated dimmer control 726, in the form of a knob, switch, or other mechanism, to allow the intensity of the semiconductor light elements 705 to be adjusted. As one example of an implementation, a dimmer control 726 (e.g., in the form of a manual knob) may control the conductance of a potentiometer or variable resistor, to adjust the amount of current reaching the semiconductor light elements 705. More than one dimmer control 726, and/or switches, may optionally be provided, so as to control groups of semiconductor light elements 705, for example, or to turn on or off certain groups of the semiconductor light elements 705. An example of electronic circuitry as may be used in connection with dimmer control 726 is described with respect to FIG. 18.

As illustrated in FIG. 7B, the panel 702 may include a socket 724 or other input for receiving a power connection (e.g., cable) to provide electrical power to the semiconductor light elements 705. The panel 702 may also include various heat dissipating fins 712, which may be arranged, for example, in arrays of metal or heat conductive rods, integrated on the back side of the panel 702, in order to efficiently dissipate heat generated by the semiconductor light elements 705. The heat dissipating fins 712 may generally be similar to those described elsewhere herein, for example, with respect to FIG. 8A. The heat dissipating fins 712 may be of any suitable size or shape, and may be extended, for example, to accommodate higher wattage LEDs or light elements. Other types of heat dissipation mechanisms may also be used.

The lighting apparatus 700 of FIGS. 8 and 9 may be particularly adapted to receive an attachable/detachable battery unit, so as to provide a power source. FIGS. 8A and 8B are diagrams of a panel-based lighting apparatus 802 such as illustrated in FIGS. 7A-B, together with an attachable battery unit 830, to form a self-contained, self-powered lighting apparatus 800. The battery unit 830 may be attachable to the panel 802 in any of a variety of manners. In the particular example shown in FIGS. 8A and 8B, the battery unit 830 comprises a set of struts 832 that attach to corresponding receptacles 836 of the panel 802. FIG. 8A shows a perspective view of the light panel 802 and battery unit 830 slightly separated, while FIG. 8B shows a side view of them attached to one another, with the struts 832 inserted in the receptacles 4836 of the panel 4802. FIGS. 9A and 9B are diagrams showing attachment of the light panel 4802 to the attachable battery unit 830. FIG. 9A in particular is a simplified diagram omitting certain details such as the heat dissipating fins.

A wide variety of alternative means may be used to attach the battery unit 830 to the panel 802; by way merely of example, the battery unit 830 may slidably attach and engage with the panel 802, or may have external tabs that grip the panel 802, or may have pins or screws that engage with the panel 802.

The battery unit 830 preferably delivers power to the light panel 802 through an electrical connector 840, which may take the form of, e.g., a jumper cord, and may insert into electrical sockets 834 (in the battery unit 830) and 824 (in the panel 802). Alternatively, the front side of the battery unit 830 and backside of the panel 802 may be provided with a mating male/female electrical plug and socket, which automatically engage when the battery unit 830 is attached to the panel 802. As with the lighting apparatus 700 of FIGS. 7A-B, a dimmer switch 826 may be provided in a convenient location on the panel 802, to adjust the light intensity. One or more batteries, possibly replaceable, may be integrated with battery unit 830. The battery, or batteries, may have a nominal voltage rating of appropriate level, such as 12 volts. The battery, or batteries, of battery unit 730 is/are preferably rechargeable in nature.

Each of the lamp segments 325-360 preferably comprises a plurality of low power lamp elements 320, such as illustrated, for example, in FIG. 3B. The low power lamps are preferably solid state in nature and may comprise, for example, light-emitting diodes (LEDs), light-emitting crystals (LECs), or other low power, versatile light sources. Slight color variations may be added relatively easily to the lenses of LEDs to compensate for color deficiencies without significantly impacting the overall light output. Colored LED lenses may also be used to generate a desired color (such as red, green, etc.), but, since colored lenses are subtractive in nature, the stronger the color, generally the more the output of the LED will be dimmed. White LEDs typically utilize clear or nearly clear lenses; however, in any of the embodiments described herein, a clear LED lens may be manufactured with slight subtractive characteristics in order to minimize any color spikes and/or non-linearities in the output of an LED.

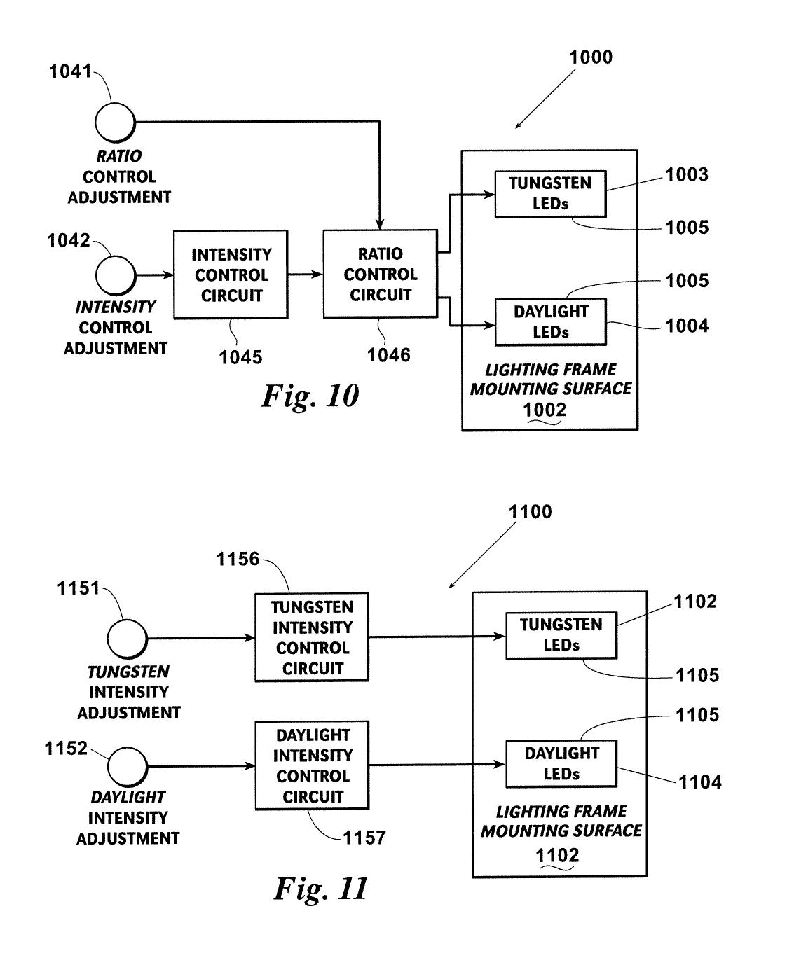

The lighting apparatuses of FIGS. 10 and 11 may, if desired, be physically embodied in a manner as described elsewhere herein. For example, the lighting apparatus may be embodied in a portable frame such as that generally illustrated in and/or described with respect to FIGS. 3, 7, 8, etc. The principles and underlying concepts associated with the embodiments of FIGS. 10 and 11 may be extended to support more than two colors of lamp elements 320 or 705. Moreover, the lighting apparatuses of FIGS. 10 and 11 may utilize any number of lamp elements in a bi-color or other multi-color arrangement in pattern.

Various embodiments of lighting apparatus as described herein utilize different color lamp elements in order to achieve, for example, increased versatility or other benefits in a single lighting mechanism. Among the various embodiments described herein are lamp apparatuses utilizing both daylight and tungsten lamp elements for providing illumination in a controllable ratio. Such apparatuses may find particular advantage in film-related applications where it can be important to match the color of lighting with a selected film type, such as daylight or tungsten.

Alternatively, or in addition, lamp elements of other colorations may be utilized. It is known, for example, to use colored lamp elements such as red, green, and blue LEDs on a single lighting fixture. Selective combinations of red, green, and blue (“RGB”) lamp elements can generally be used to generate virtually any desired color, at least in theory. Lighting systems that rely upon RGB lamp elements can potentially used as primary illumination devices for an image capture system, but suffer from drawbacks. One such problem is that the red, green, and blue colors generated by the light elements do not necessary mix completely. The discrete RGB lamp elements (e.g., LEDs) each project a localized “pool” of its individual primary color. This manifests as spots of color, or bands of individual or partially mixed colors. One of the presently available solutions to correct for this problem is mixing the colors using a diffusion technique. Diffusion mixing can be accomplished by adding defractors, gratings, or white opal-appearing filters, for example. Unfortunately, these techniques end up reducing the overall output of the lighting apparatus and, more importantly, severely reduce the ability of the LEDs to “project” light in a direct fashion. Another problem for illumination systems which rely upon RGB color mixing is that not all of the LEDs are generally used at full power for most lighting situations. One or two of the LED color groups typically have to be dimmed in order for the desired color to be generated, which can further reduce the overall light output. When these factors are considered in combination, RGB based lighting apparatus may not be well suited for providing primary illumination for image capture applications (such as film).

While the foregoing discussion has principally focused on RGB based lighting apparatus, similar problems and drawbacks may be experienced when employing lamp elements in other color combinations as well.

In various embodiments as disclosed herein, a lighting apparatus is provided which utilizes two or more complementary colored lamp elements in order to achieve a variety of lighting combinations which, for example, may be particularly useful for providing illumination for film or other image capture applications. A particular example will be described with respect to a lighting apparatus using lamp elements of two different colors, herein referred to as a “bi-color” lighting apparatus. In a preferred embodiment, the bi-color lighting apparatus utilizes light elements of two different colors which (unlike red, green, and blue) are separated by a relatively small difference in their shift or color balance. When reference is made herein to light elements of two different colors, the light elements may, for example, include a first group which provide light output at a first color and a second group which provide light output at a second color, or else the light elements may all output light of a single color but selected ones of the light elements may be provided with colored LED lenses or filtering to generate the second color. In a preferred embodiment, as will be described, the bi-color lighting apparatus uses lamp elements having daylight and tungsten hues (for example, 5200° K and 3200° K color temperatures, respectively). Other bi-color combinations may also be used and, preferably, other combinations of colors which are closely in hue or otherwise complementary in nature.

One possible advantage of a bi-color lighting system as will be described in certain embodiments below is the ability to more easily blend two similar colors (e.g., 5500 K and 3200 K color temperature hues), particularly when compared to a tri-color (e.g., RGB) lighting system that relies upon opposing or widely disparate colors. The blending process of two similar colors is not nearly as apparent to the eye, and more importantly in certain applications, is a more suitable lighting process for film or video image capture devices. In contrast, attempting to blend 3 primary or highly saturated (and nearly opposite colors) is much more apparent to the eye. In nature one may visually perceive the blending of bi-colors, for example, from an open sky blue in the shade, to the warmth of the direct light at sunset. Such colors are generally similar, yet not the same. Their proportion in relation to each other is a naturally occurring gradient in most every naturally lit situation. This difference is the basis of most photographic and motion picture lighting hues. These hues give viewers clues as to time of day, location and season. Allowing separate control of the two different color lamp elements (such as LEDs), through two separate circuit/dimmer controls or otherwise, provides the ability to easily adjust (e.g., cross-fade, cross-dim, etc.) between the two colors because they do not have significant color shifts when dimmed and blend in a visually pleasing manner, allowing the type of color gradients that occur in nature. In addition, virtually all still and motion picture film presently used in the industry is either tungsten or daylight balanced, such that various combinations of daylight and tungsten (including all one color) are well matched directly to the most commonly used film stocks. These features make various of the lighting apparatus described herein particularly well suited for wide area still, video, and motion picture usage, especially as compared to RGB-based or other similar lighting apparatus. The above principles may also be extended to lighting systems using three or more lamp element colors.

FIG. 10 is a block diagram of one embodiment of a lighting effects system 1000 having at least two different lamp element colors. As illustrated in FIG. 10, the lighting effects system 1000 comprises a lighting frame mounting surface 1002 having a plurality of lamp elements 1005 which, in this example, include daylight LEDs 1004 and tungsten LEDs 1003, although different lamp elements and/or different colors could be chosen. The lighting effects system 1000 further comprises various control electronics for controlling the illumination provided by the lamp elements 1005. In particular, the lighting effects system 1000 comprises an intensity control adjustment 1042, an intensity control circuit 1045, a ratio control adjustment 1041, and a ratio control circuit 1046. The intensity control adjustment 1042 and ratio control adjustment 1041 may each be embodied as, e.g., manual control knobs, dials, switches, or other such means, or alternatively may be embodied as a digital keypad, a set of digital buttons, or the like. A visual display (not shown) such as an LCD display may be provided to allow the operator to view the settings of the intensity control adjustment 1042 and ratio control adjustment 1041. Alternatively, the ratio control adjustment 1041 and/or intensity control adjustment 1042 may comprise digital commands or values received from a computer or similar device.

In operation, setting the intensity control adjustment 1042 selects the illumination level for the lamp elements 1005, while setting the ratio control adjustment 1041 selects the relative intensities between, in this example, the daylight LEDs 1004 and the tungsten LEDs 1003. The intensity control circuit 1052 and ratio control circuit 1046 may comprise analog and/or digital circuitry, and the output of the ratio control circuit 1046 modifies the incoming power supply separately for the daylight LEDs 1004 and the tungsten LEDs 1003 in a manner dictated by the setting of the ratio control adjustment 1041. Accordingly, by use of the ratio control adjustment 1041, the operator may select more daylight illumination by increasing the relative intensity of the daylight LEDs 1004 or may select more tungsten illumination by increasing the relative intensity of the tungsten LEDs 1003. To increase or decrease the overall light output intensity, the operator may adjust the intensity control adjustment 1042. The lighting effects system 1000 thereby may provide different combinations of daylight/tungsten coloration to match a wide variety of settings and circumstances, with the two colors being generally complementary in nature and thus providing a balanced, well blended illumination effect.

FIG. 11 is a diagram of another embodiment of a lighting effects system having at least two different lamp colors. As illustrated in FIG. 11, and similar to FIG. 10, the lighting effects system 1100 comprises a lighting frame mounting surface 1102 having a plurality of lamp elements 1105 which, in this example, include daylight LEDs 1104 and tungsten LEDs 1103, although different lamp elements and/or different colors could be chosen. The lighting effects system 1100, as with that of FIG. 10, further comprises various control electronics for controlling the illumination provided by the lamp elements 1105. In particular, the lighting effects system 1100 comprises individual intensity control adjustments 1151, 1152 for daylight and tungsten lamp elements (e.g., (LEDs) 1103, 1104, and individual intensity control circuits 1156, 1157 also for the daylight and tungsten LEDs 1103, 1104. The tungsten intensity control adjustment 1151 and daylight intensity control adjustment 1152 may, similar to FIG. 10, each be embodied as, e.g., manual control knobs, dials, switches, or other such means, or alternatively may be embodied as a digital keypad, a set of digital buttons, or the like. A visual display (not shown) such as an LCD display may be provided to allow the operator to view the settings of the two intensity control adjustments 1151, 1152. Alternatively, the intensity control adjustments 1151, 1152 may comprise digital commands or values received from a computer or similar device.

In operation, setting the tungsten intensity control adjustment 1151 selects the illumination level for the tungsten LEDs 1103 via the tungsten intensity control circuit 1156, and setting the daylight intensity control adjustment 1152 selects the illumination level for the daylight LEDs 3404 via the daylight intensity control circuit 1157. The relative settings of the tungsten intensity control adjustment 1151 and the daylight intensity control adjustment 1152 generally determine the relative intensities between, in this example, the daylight LEDs 1104 and the tungsten LEDs 1103. The intensity control circuits 1156, 1157 may comprise analog and/or digital circuitry, and the relative outputs of the tungsten intensity control circuit 1156 and the daylight intensity control circuit 1156 generally determine the illumination level and composition. The operator may select more daylight illumination by increasing the relative intensity of the daylight LEDs 1104 or may select more tungsten illumination by increasing the relative intensity of the tungsten LEDs 1103. The lighting effects system 1100 thereby may provide different combinations of daylight/tungsten coloration to match a wide variety of settings and circumstances, as with the FIG. 10 embodiment.

Because the two different colors of LEDs (e.g., daylight and tungsten) can be controlled separately (through common or separate circuitry), and because these particular LEDs, or other similar complementary colors, do not have significant color shifts when dimmed, it would be relatively straightforward to adjust (e.g., cross-fade, cross-dim) between the two colors and, for example, provide a variety of natural light illumination effects for various types of common film stock.

According to one or more embodiments as disclosed herein, a versatile lighting apparatus in the form of an LED-based light panel is provided, preferably having a variety of mounting options or configurations, an attachable or integrated battery unit, and alternative means for receiving a power supply input. In a preferred embodiment, the versatile LED-based light panel includes a panel frame, and a plurality of LEDs or other light elements secured to the panel frame. A self-contained battery unit securably attaches to the outside of the panel frame. The light panel may have a dimmer switch, and may also be capable of receiving power from a source other than the self-contained battery unit. The lighting apparatus can be mounted to a camera or a stand through adapters. Diffusion lenses or color gels can be integrated with or detachable from the light panel. The lighting apparatus may conveniently be provided in the form of a kit, with one or more of a light panel, self-contained battery unit, compact stand, connecting cable(s), adapter(s), lenses or color gels, and so on, provided in a single package.

It is contemplated that the lighting and effects generator of the present disclosure could, due to its size and weight, be transported quickly and easily by a photographer to a location and rapidly setup to produce a lighting and effects system which provides continuous source of illumination for modeling and video capture as well as pulse, flash or strobe boost illumination for still photography. Such a system capable of being battery powered would not require cabling and thus could be used in crowded areas without a concern of someone tripping over cables. A portable and therefor spontaneous battery powered, cordless, LED studio can be set up at any desired location.

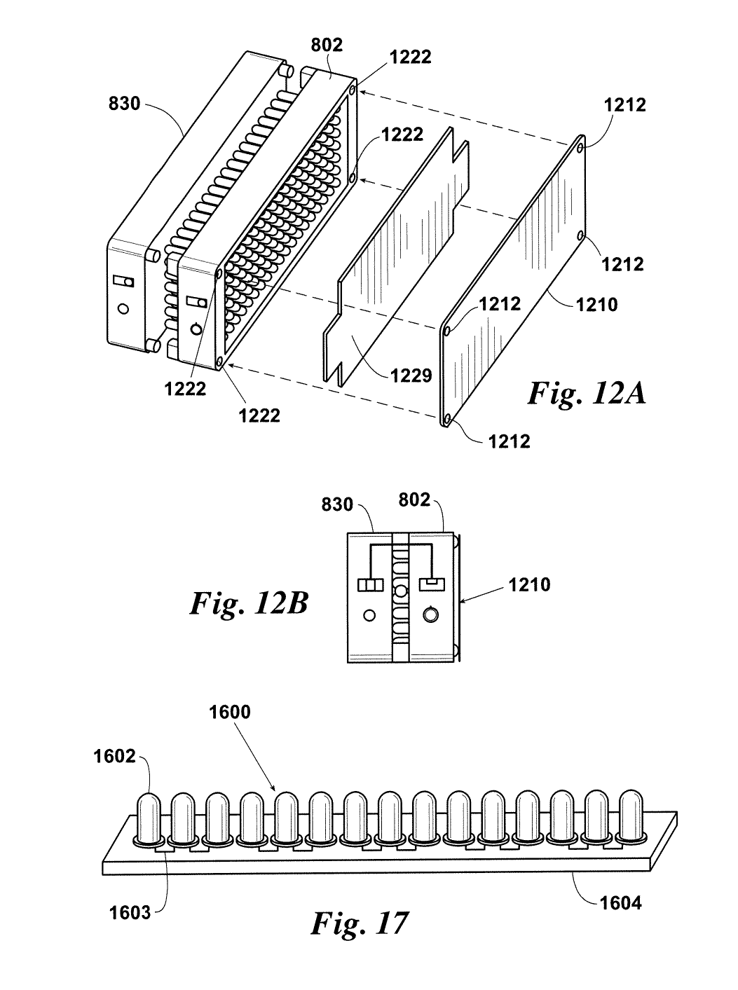

A diffusion lens or filter may also be used, by itself or in conjunction with a color gel or colored lens, to diffuse or soften the outgoing light. A diffusion lens or filter may be formed of, e.g., clear or white opaque plastic, and may be configured in a shape of similar dimension to the panel 702 or 802 to facilitate mounting thereon. One such diffusion filter 1229 is shown in FIG. 12A. A preferred diffusion filter/lens would be a Light Shaping Diffusor material (e.g., holographic, etc.). A color correction mechanism, such as a lens filter and/or color gel, may be used to alter the color of the light elements of a lighting apparatus such as depicted in FIGS. 7A-B or 8A-B. For example, LED light sources could, if necessary, be converted to “tungsten daylight” (similar in hue to an incandescent bulb) by use of a color gel and/or colored lens.

The lighting apparatuses 700 and 800 are preferably adapted to be utilized in conjunction with various lenses and/or color gels, to increase their versatility. FIG. 12A is a diagram illustrating one embodiment having a lens 1210 and optional color gel 1229 used with the lighting apparatus 800 illustrated in FIGS. 8A-B, and FIG. 12B is a side view diagram illustrating the lens 1220 in place. The lens 1210 is preferably readily attachable to the panel 802 of the lighting apparatus 800, by fastening means such as complementary Velcro patches 1222, 1212. Alternatively, the lens 1210 could snap or slide on to the panel 802, or be attached using screws, nuts/bolts, pins, or other such means. The filter/lens 1210 (as with 6327, described later herein) may comprise, e.g., a Fresnel lens, a holographic lens, or any other type of lens, or combinations thereof. The color gel 1229 is preferably inserted beneath the lens 1210 and is secured beneath it. As depicted in FIG. 12A, the color gel 1229 has cutouts on each of the corners so as not to interfere with the Velcro patches 1222, 1212.

The lighting apparatus 700 is preferably portable in nature and can be adapted for use in a variety of ways. To facilitate mounting of the lighting apparatus 700 (whether or not attached to a battery unit, as depicted in FIGS. 8A-B), the lighting apparatus 700 may be provided with one or more adapters. FIG. 59 is a diagram illustrating an example of a lighting apparatus 700 in the form of a panel 702 with one or more adapters 5906, 5907 for mounting or affixing the panel 702 to a camera, stand, or other object or surface. In the example depicted in FIG. 59, the adapters 5906, 5907 are in the form of receptacles suitable for receiving a mechanical pin (or a similar fastener such as a screw or bolt), allowing convenient and rapid deployment of the lighting apparatus 700 on, e.g., a camera or stand. Other adapters or fastening means (e.g., hinged tabs, sliding/coupling members, etc.) may also be used.

Examples of ways in which the light apparatus 700 can be mounted on a camera, stand or other object or surface are illustrated in at least FIGS. 1, 3, 4, etc. For example, the lighting apparatus 700 may be mounted to a camera, directly to the camera housing or to an arm attached to the camera housing. FIG. 1A is a diagram showing one possible mechanism for mounting a lighting apparatus 700 in the form of a light panel to a camera 1307. While the description below is explained in terms of lighting apparatus 700, it also applies to the lighting apparatus 800 having an attachable battery unit, as well as other possible lighting apparatuses as well. In FIG. 13, the camera 1307 includes or is configured with an attachment arm 1310 which may be used for mounting the lighting apparatus 700.

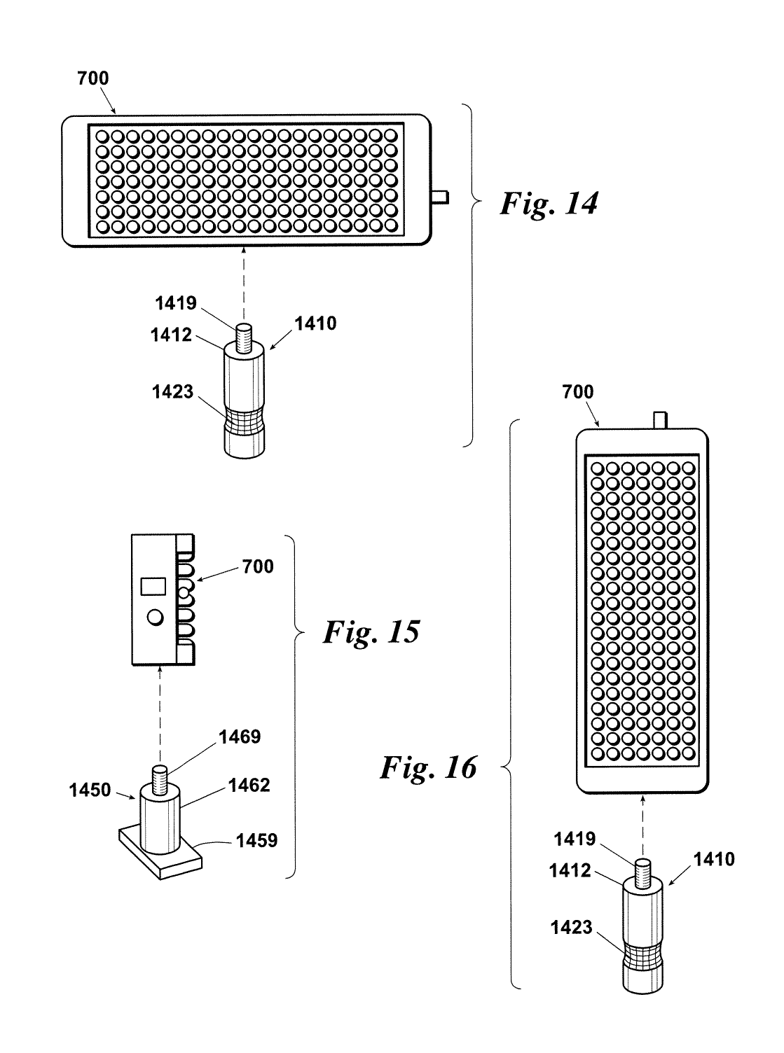

FIGS. 14 through 16 are diagrams illustrating other attachment options, using various mounting pins, in connection with the lighting apparatus 700 of FIGS. 7A-B. FIG. 14, for example, illustrates a mounting pin 1410 that may be used to allow the lighting apparatus 700 to attach to a stand or tripod.

FIG. 16 illustrates attachment of the lighting apparatus 700 to a mounting pin 1410 similar to that shown in FIG. 14, but in this instance being coupled to an adapter on the narrow side of the lighting apparatus 700 instead of its long side.

In FIG. 15, the lighting apparatus 700 is attached to a stand or camera using a mounting pin 1450. The mounting pin 1450 in this example also includes a threaded pin 1469 and a cylindrical body 1462. In this case, the mounting pin 1450 may have a T-bar 1459 that is securably attached to the cylindrical body 1462, or else fits into a hollow receptacle to secure it to the cylindrical body 1462 of the mounting pin 1450, thereby allowing it to slide onto a camera having curved fins or other members for receiving the wings of the T-bar 1459. The mounting pin 1450 may alternatively have a pin, receptacle, or other member for mounting into a camera shoe or a stand, thus securing the lighting apparatus 700 to the camera or stand.

Various options and accessories as may be used in connection with the lighting assembly frame. The lighting frame may be augmented with a diffusion filter and/or a color filter which may, if desired, be secured into place through a cover (e.g., a clear plastic cover) which locks or snaps onto the lighting frame. Similar accessories may be utilized, for example, in connection with the lighting frame 302 illustrated in FIGS. 3 and 4. Illustrations of filtering techniques, through the use of waveguides and other means, are described, for example, in U.S. Pat. Nos. 6,272,269 and 6,270,244, both of which are incorporated by reference herein in their entirety.

It will be appreciated that, in various embodiments, a flexible, lightweight and functional lighting effects system is provided, whereby relatively uniform light may be used in illumination of a subject or area. The lighting effects system may, in various embodiments, allow a lighting frame to be secured to a camera or other image capture device, so as to permit the lighting system to be mobile and move in tandem with the camera or other image capture device, if desired. Also, in various embodiments, the lighting effects system may provide a variety of lighting patterns, including programmable patterns by which individual or groups of lights can be controlled for different lighting effects. The lighting frame may, in certain instances, be formed in multiple sections and hinged to allow the lighting frame to fold, or else snapped apart section by section, for ease of transport.

The light and effects generator of the present disclosure may be adapted for implementation into a soft box. This would allow for the projection of a soft light deep into a subject. The advantages of such a soft light embodiment include all of the known advantages of a soft box such as the use of diffusion and control of the light with little light loss.

The particular advantages of the light and effects generator of the present disclosure implemented in a soft box include the fact that the LED light array generates less heat than conventional systems and particularly the fact that it provides a large light source with a flash with minimal feature depth. This is particularly significant for overhead lighting applications or anywhere where space is a factor in light placement.

In addition, a light of the present disclosure in a soft box could also include lensing and/or multi lensing. Contiguous lensing could be provided to create a seamless light source over the entire face of the light. Such light could then be projected deep into a subject for photography.

Another aspect of the light and effects generator of the present disclosure is that when coupled with a camera, it is possible to use the camera as a light meter without the requirement of an additional light meter. In this way, a color chart, well known in photography is used in view of the camera. A test shot is then performed using the color chart. The lighting information matching the color chart is then transferred directly to the light of the present disclosure to balance the color. This information is transferred in a communication either wired or wireless communication between the camera and the microcontroller in the light. In this way color brightness control may be achieved as well as the depth of the lighting and changes of color in relation to depth.

In various alternative embodiments, the lighting frame need not be shaped as shown in FIGS. 1, 3, 4, etc. For example, the lighting frame may be round, square, hexagonal, octagonal, or other polygonal, or could, for instance, have a partially polygonal shape. Preferably, the lighting frame is relatively thin, as compared to its overall size, although it need not be. Also, the lighting frame preferably has a hole generally centered therein to allow a camera or other image capture device to view through the frame, although in some embodiments a viewing hole may not be present. The exterior portion of the lighting frame, or at least the exterior portion thereof, is preferably made of a lightweight, durable material such as plastic and/or lightweight metal (e.g., aluminum), optionally anodized, although in various embodiments it can be made of other materials as well, including any type of metal, wood, plastic, or combination thereof. The interior lighting frame portion may advantageously comprise a printed circuit board.

Other variations may pertain to the manner of attaching the lighting frame to a camera or other image capture device. Rather than using a single mounting bracket or assembly, for example, multiple mounting brackets or assemblies may be used. Also, the mounting bracket or assembly may be permanently attached or affixed to the lighting frame, and may be, for example, retractable or foldable for convenience of transportation. The lighting frame may attach either to the camera body or to the lens portion of the camera. The lighting frame may attach to the camera lens through any of a variety of means, such as by engaging an outer camera lens threading through a threading on the interior circular hole of the lighting frame, engaging an inner camera lens threading by providing a complementary threaded extension for that purpose, by a strap means to secure the lighting frame to the camera and/or stand, or by a “hose-clamp” type strap which grips the outer cylinder of the camera lens. Also, rather than attaching to the camera, the lighting frame may be portable, and may be outfitted with handles for lighting crew to manually carry or hold the lighting frame, or may be adapted to attach to a stand or fixture for providing stationary illumination. The lighting frame may also be adapted to attach to a machine arm or other contrivance for allowing the lighting effects system to be moved as needed for filming or other desired purposes.

Further embodiments, variations, and modifications pertain to the type of lamp elements that may be utilized in a lighting effects system and/or the manner of constructing a lighting frame particularly well suited for placing numerous lamp elements thereon. One method of construction involves the use of surface mount LEDs. A surface mount LED may have a lens atop the body that directs the light generated by the surface mount LED outwards. While the body and the lens of the surface mount LED may radiate heat, its tabs as well as the thermal shoe on the bottom surface assist in conducting heat to the mounting surface (e.g., circuit board) and thus may provide advantageous heat dissipation capabilities, particularly as compared to non-surface mount LEDs which tend to dissipate heat typically through their leads. Use of surface mount LEDs provides a larger and more direct heat conduction path to the mounting surface (e.g., circuit board), and may also provide advantages in ease of fabrication and improved durability.

In various embodiments as described herein, the lamp elements used in a lighting effects system or lighting apparatus may comprise high output semiconductor lights such as, for example, high output LEDs. Such high output LEDs are available from Lumileds Lighting, LLC of San Jose, Calif. under the product brand name Luxeon™. High output LEDs are presently available in white as well as colors such as green, blue, red, amber, and cyan, are fully dimmable, and generally operate at about one to several Watts (e.g., 5 Watts), outputting in certain devices approximately 24 or more lumens per Watt. The high output LEDs may be mounted upon, e.g., a metal printed circuit board (PCB) such as an aluminum core circuit board. High output LEDs may be used in connection with any of the embodiments previously described herein, and may provide advantages of increased lighting output with fewer lamp elements and, hence, reduced cost of construction in certain cases. However, the driving circuitry for the high output LEDs would generally need to have a higher output rating than the circuitry used for lower power LEDs.

FIG. 17 is a generalized diagram of an array of LEDs 1602 mounted atop a circuit board 1604, as may be used in various embodiments as described herein. The circuit board 1604 may comprise rigid fiberglass or phenolic planes with electrically conductive tracks etched on them, and/or may be metallic in nature (such as aluminum core PCBs). The term “circuit board” as used herein is meant to encompass the foregoing structures as well as various other types mounting apparatus, including flexible electrical interconnects such as conductive membranes made on thin Mylar, silicone, or other similar materials. The surface mount LEDs 1602 may be connected together in series and/or in parallel by electrical traces 1603 on the circuit board 1600. While the LEDs 1602 are illustrated in FIG. 17 as being in a straight-line array, other LED patterns may also be utilized. As previously mentioned, the tabs and thermal shoe on the bottom each of the surface mount LEDs 1602 generally assist in conducting heat to the circuit board 1604, thus providing advantageous heat dissipation capabilities.

A lighting apparatus may conveniently be packaged in the form of a kit that includes a number of components providing increased convenience, flexibility, and adaptability to operators in the field. For example, a lighting apparatus kit may include one or more lighting panels 702, as well as one or more battery units 830 (and/or battery adapters such as described previously herein), power jumper cable (for connecting the power between the panel(s) 702 and battery unit(s) 830, an AC adapter and power/recharging cable, one or more lenses 1210, a set of colored or diffusion gels 1259 of various tints and hues, or providing light shaping or diffusion (such as with a Fresnel lens or holographic lens), and/or one or more compact mounting stands (or other accessories described herein), all of which can be packaged conveniently in a portable case. The colored or diffusion gels may be integrated with a panel, or else detachable.

The lighting apparatus and/or battery unit may have electronics which also provide increased performance, versatility, and/or flexibility.

FIG. 18 is a functional block diagram illustrating an example of circuits or components of an LED-based light panel 1800, as may be constructed in accordance with, e.g., light panel 702 or 802 described elsewhere herein. The LED-based light panel 1800 in this example includes a power regulator 1810 which preferably provides a relatively constant or stabilized current output to one or more arrays or series of LEDs 1840 (or other semiconductor light elements). Details of possible embodiments of a power regulator 1810 are described in U.S. Pat. No. 7,569,996, entitled “Omni-Voltage Direct Current Power Supply,” hereby incorporated by reference as if set forth fully at this point. The power regulator 1810 preferably includes a switched power supply 1820 under control of a control circuit 1825, such as a PIC microcontroller 1825. The switched power supply 1820 may be a buck/boost power supply, or else simply a buck or boost power supply, or other type of power supply. A buck/boost power supply allows the most flexibility, in that the input voltage could vary over a relatively wide range; a particular example is described in application Ser. No. 10/708,717 referred to above. A voltage sense circuit 1831 and current sense circuit 1832 provide feedback information to the PIC microcontroller 1825, which information is used in maintaining the output current to the LEDs 1840 at a stable level, and thereby reducing undesirable artifacts such as flicker.

In FIG. 18, a dimmer switch 1826 adjusts a potentiometer or variable resistor 1835, which in turn provides a dimming control input signal 1837 to the power regulator 1810. In a preferred embodiment, the dimmer control input signal 1837 adjusts the level of gain in a feedback loop for the PIC microcontroller 1825, thus allowing adjustment of the amount of output current for the LEDs 1840. The circuitry of FIG. 18 can allow, for example, the adjustment of light intensity without a substantial change in the output color temperature of the light source (i.e., the LEDs), and again, without flicker even at relatively low light output levels. These can be significant advantages to those working in the field.

The battery unit 830 described previously herein may take on various different forms and configurations. In alternative embodiments, for example, the battery unit 830 may, for example, comprise one or more “standard” or conventional camera batteries, as may be obtained by companies such as, e.g., Sony, Panasonic, Canon, and the like. A preferred battery compartment will include an adapter panel for receiving at least one attachable battery, such as a DV (“digital video”) battery. A DV type battery typically has a battery casing designed to be snapped directly into the camera, although DV batteries may differ from camera manufacturer to manufacturer. The adapter panel is preferably constructed to mate to a particular type or brand of battery, and thus different adapter panels may be made available, each suited to a particular battery or family of batteries. At least some DV batteries output less than 12 volts—for example, a typical output voltage is 7.2 volts. The battery unit may comprise two receptor plates each adapted to securably attach a battery to the adapter panel. Electrical contacts provide electrical connection from the battery to downstream electronics or a power output source. The battery or batteries may be electrically connected in series via electronics integrated in the adapter panel, thus doubling the voltage to, e.g., 14.4 volts. Alternatively, the adapter panel could include a transformer of other type of DC-DC conversion circuitry to step up the voltage to 12 volts or some other appropriate level.

The battery unit will preferably include struts or other attachment means in order to allow the battery unit to readily attach to, e.g., an LED based light panel 802, in a manner similar to the way in which battery unit 830 may connect to the panel 802.

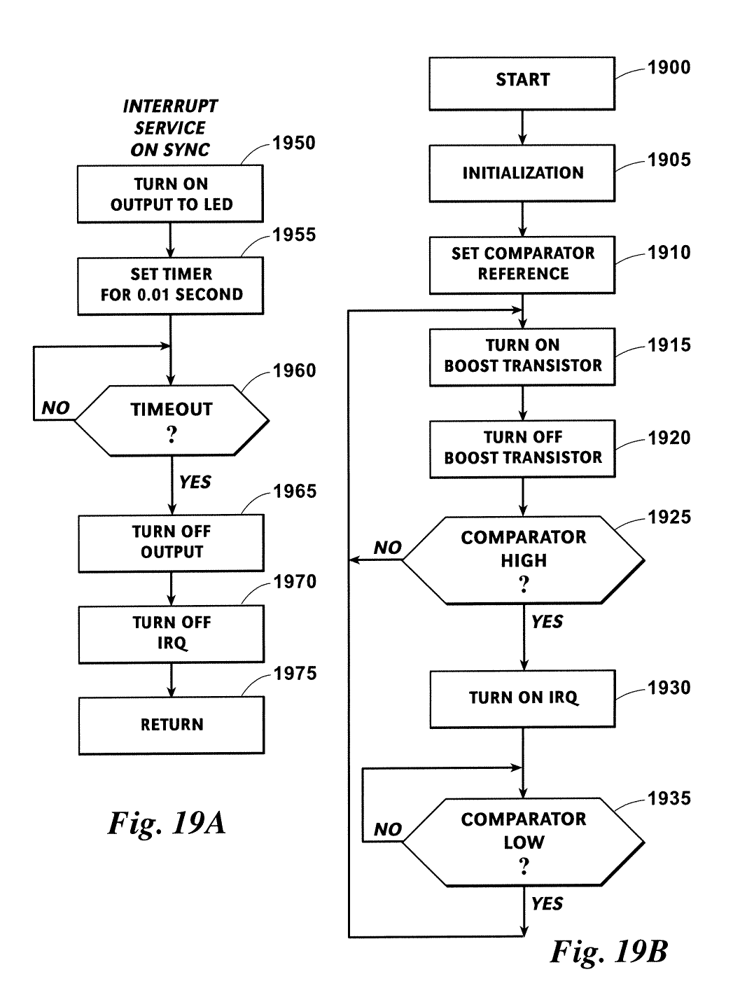

Finally, FIGS. 19A and B illustrate some logic suitable for use with the preferred embodiment of the instant invention. More particularly, such operations as are illustrated in FIG. 19 might be implemented within microcontroller 626, controller 1825, etc. Procedure 1900 is designed to prepare the instant light to fire in burst mode upon receipt of a signal from an associated camera or other electronic device. As a first preferred step 1905, the instant routine will preferably initialize its variables according to methods well known to those of ordinary skill in the art. As a next preferred step, a comparator reference value will be selected (step 1910). In some preferred embodiments, a comparison will be made between the voltage in the capacitor that will be used to power the flash and a reference voltage that might be, for example, found within the microprocessor. In some preferred embodiments, a voltage divider will used to make the voltages between the capacitor (which might be, for example, 50 volts or so) and microprocessor (e.g., five volts) comparable. That being said, those of ordinary skill in the art will recognize that this is only one method of implementing this step and other methods such as A/D conversion, analog circuitry, etc. could be used instead of a voltage divider. Additionally, those of ordinary skill in the art will realize that discrete circuitry equivalents of the operations in 19A and 19B could readily be constructed by those of ordinary skill in the art.

Next, and preferably, a loop will be entered, a purpose of which is to build up a reservoir of power for use by the LED array when a flash or burst is requested. As is indicated in FIG. 19B, preferably the boost transistor will be activated (step 1915) and then deactivated (step 1920), thereby incrementally charging the flash capacitor. Next, and preferably, a comparison will be made between the reference voltage and the voltage in the flash capacitor (step 1925) and if the comparator is “low,” the preferred logic would branch back to step 1915, where additional power will be added to the flash capacitor. However, if the comparator is “high”, (i.e., the “yes” branch of decision item 1925), the instant invention will then preferably proceed to turn on the IRQ (i.e., interrupt request line), step 1932.

Next, the instant invention will next preferably loop continuously checking for a low state of the comparator (decision item 1935), thereby allowing for the possibility of leakage in the capacitor and correcting same if it occurs. If the comparator “low” value is “no,” the instant invention will stay in its current loop. However, if the decision item 1935 returns a value of “yes,” the instant invention will preferably branch up to step 1950 where additional power will be added.

Then, when a sync signal is sensed (or if a photographer manually activates the flash mode), in a preferred arrangement an interrupt will be generated that transfers control to routine 1950.

As a first preferred step in that routine, the output to the LED will be activated, thereby transferring power from the capacitor to the LEDs and activating them (step 1950). Next, and preferably, a timer will be set for a predetermined period of time (step 1955). Although many different time periods might be used (including variable time intervals that would be responsive to through-the-lens metering requirements), in a preferred embodiment the timer will be set to 0.01 seconds. This is the length of time the LED array will be activated and, hence, the duration of the flash.

Step 1960 is a decision item that is designed to implement the timer value set in the previous step. Until the timer value is reached, the LEDs will remain activated and decision item will keep looping. Once the appropriate period of time has passed (i.e., the “yes” branch of decision item 1960), the output to the LED will be terminated (step 1965), thereby ending the flash. Next, and preferably, the IRQ will be turned off (step 1970) in preparation for a return to the procedure 1900 or some other procedure in the software of the instant invention (step 1975).

Upon return to procedure 1900, the voltage across the capacitor will dip well below the threshold due to the energy delivered to flash the LEDs. Thus at decision 1935, control will return to step 1915 to toggle the boost transistor and recharge the capacitor. When accomplished, the IRQ will be re-enabled to allow another flash to occur.

Certain embodiments have been described with respect to the placement of lamp elements (e.g., LEDs) on a “mounting surface” or similar surface or area. It will be appreciated that the term “mounting surface” and other such terms encompass not only flat surfaces but also contoured, tiered, or multi-level surfaces. Further, the term covers surfaces that allow the lamp elements to project light at different angles.

Certain embodiments have been described with respect to the placement of lamp elements (e.g., LEDs) on a “mounting surface” or similar surface or area. It will be appreciated that the term “mounting surface” and other such terms encompass not only flat surfaces but also contoured, tiered, or multi-level surfaces. Further, the term covers surfaces which allow the lamp elements to project light at different angles.

Various embodiments have been described as having particular utility to film and other image capture applications. However, the various embodiments may find utility in other areas as well, such as, for example, automated manufacturing, machine vision, and the like.

Those of ordinary skill in the art will understand that the term “microprocessor” as used herein should be broadly construed to include any device that is capable of being programmed including, without limitation, controllers, microcontrollers, gate arrays, programmable logic devices (“PLD”), etc. Thus, for purposes of the instant disclosure the terms “processor,” “microprocessor” and “CPU” (i.e., central processing unit) should be interpreted herein to take the broadest possible meaning, and such meaning is intended to include any PLD or other programmable or active device of the general sort described above.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. A camera illumination system for image capture, comprising:
(a) a camera having at least a video mode and a still picture mode;
(b) at least one LED in electronic communication with said camera, said at least one LED illuminating at least a portion of a field of view of said camera when said LED is activated; and
(c) control circuitry in electronic communication with said LED and with said camera, said control circuitry at least for activating said at least one LED to a strobe mode when said camera is in said still picture mode and a continuous illumination mode when said camera is in said video mode.

2. The camera illumination system for image capture according to claim 1, wherein said at least one LED comprises a plurality of LEDs arranged in an array.

3. The camera illumination system for image capture according to claim 1, wherein said control circuitry comprises:
(1) a sync connector in electronic communication with said camera,
(2) a microprocessor in electronic communication with said sync connector and with said at least one LED, said microprocessor being programmed to at least activate said LED to a strobe mode or to a continuous illumination mode in response to a signal from said sync connector.

4. The camera illumination system for image capture according to claim 1, wherein said at least one LED is removably attached to said camera.

5. The camera illumination system for image capture according to claim 1, wherein said camera is selected from a group consisting of a digital still camera, a film camera, a video camera, a motion picture camera, a photography camera, and a digital video camera.

6. An area illumination system, comprising:
(a) at least one LED; and,
(b) circuitry in electronic communication with said LED, said circuitry at least for activating said LED in either a strobe mode or a continuous mode.

7. The area illumination system according to claim 6, wherein said at least one LED comprises a plurality of LEDs arranged in an array.

8. The area illumination system according to claim 6, wherein said at least one LED comprises a linear LED array.

9. The area illumination system according to claim 6, wherein said control circuitry comprises:
(1) a sync connector in electronic communication with said camera,
(2) a microprocessor in electronic communication with said sync connector and with said at least one LED, said microprocessor being programmed to at least activate said LED to either a strobe mode or to a continuous illumination mode in response to a signal from said sync connector.

10. The area illumination system according to claim 6, wherein said at least one LED is removably attached to a camera.

11. The camera illumination system for image capture according to claim 10, wherein said camera is selected from a group consisting of a digital still camera, a film camera, a video camera, a motion picture camera, a photography camera, and a digital video camera.

12. An area illumination system for lighting a subject for film, photography or video, the illumination system comprising:
(a) a portable frame, said portable frame adapted for temporary mounting to a movable camera apparatus such that said portable frame follows the movements of the camera apparatus, said portable frame being readily detachable from the camera apparatus;
(b) a plurality of LEDs arranged in a plurality of linear rows across a front face of said frame for lighting the subject for film, photography, or video; and,
(c) an effects generator which is configurable to activate said LEDs in at least two different modes, wherein said at least two different modes comprise a first mode that generates a flash of light from said plurality of LEDs and a second mode that generates a continuous light from said plurality of LEDs.

13. The camera illumination system for image capture according to claim 12, wherein said camera is selected from a group consisting of a digital still camera, a film camera, a video camera, a motion picture camera, a photography camera, and a digital video camera.

14. The camera illumination system for image capture according to claim 12, wherein said effects generator comprises:
(1) a sync connector in electronic communication with said camera,
(2) a microprocessor in electronic communication with said sync connector and with said at least one LED, said microprocessor being programmed to at least activate said LED to a strobe mode or to a continuous illumination mode in response to a signal from said sync connector.

15. An area illumination system for lighting a subject for film, photography or video, the illumination system comprising:
(a) a portable frame, said portable frame adapted for temporary mounting to a movable camera apparatus such that the portable frame follows the movements of the camera apparatus, said portable frame being readily detachable from the camera apparatus;
(b) a plurality of LEDs secured to said frame for lighting the subject for film, photography, or video;
(c) a dimmer integrated with said portable frame, said dimmer configured to provide manual adjustment of an illumination intensity of said light emitting diodes; and
(d) an effects generator which is configurable to activate said LEDs in at least two different modes, wherein said at least two different modes comprise a first mode that that generates a flash of light from said plurality of LEDs and a second mode that generates a continuous light from said plurality of LEDs.

16. An area illumination system for lighting a subject for film, photography or video, the illumination system comprising:
(a) a frame, said frame adapted for being mounted to and readily disengaged from a stand, a plurality of light emitting diodes (LEDs) arranged across a front face of said frame for lighting the subject for film, photography, or video; and
(b) an effects generator which is configurable to activate said LEDs in at least two different modes, wherein said at least two different modes comprise a first mode that that generates a flash of light from said plurality of LEDs and a second mode that generates a continuous light from said plurality of LEDs.
